(19) United States
(12) Patent Application Publication
(10) Pub. No.: US 2026/0134775 A1
(43) Pub. Date: May 14, 2026

(54) VEHICLE DRIVING ASSISTANCE APPARATUS

(71) Applicant: TOYOTA JIDOSHA KABUSHIKI KAISHA, Aichi (JP)

(72) Inventor: Hikaru AKIMOTO, Mishima-shi (JP)

(21) Appl. No.: 19/344,529

(22) Filed: Sep. 30, 2025

(30) Foreign Application Priority Data
Nov. 11, 2024 (JP) 2024-196612

(51) Int. Cl. G08G 1/0967; G08G 1/16

(52) U.S. Cl. CPC G08G 1/0967; G08G 1/166

(57) ABSTRACT

A vehicle driving assistance apparatus notifies an operator of a vehicle of a moving body when recognizing the moving body based on wireless communication information. The moving body moves toward an intersection ahead of the vehicle. The moving body satisfies a predetermined condition. The predetermined condition includes a first condition that a moving speed of the moving body is equal to or lower than a first speed and an intersection arrival margin time is within a range equal to or shorter than a first time and equal to or longer than a second time shorter than the first time. The intersection arrival margin time is the time remaining until the moving body arrives at the intersection. The apparatus notifies the operator of the presence of the moving body when recognizing the presence of the moving body satisfying the first condition.

### CROSS-REFERENCE TO RELATED APPLICATIONS

This application claims priority to Japanese patent application No. JP 2024-196612 filed on Nov. 11, 2024, the content of which is hereby incorporated by reference in its entirety.

### BACKGROUND

### Field

The present invention relates to a vehicle driving assistance apparatus.

### Description of the Related Art

There is known a vehicle driving assistance apparatus which recognizes, based on wireless communication information, the presence of a moving body that may collide with a host vehicle, and notifies an operator of the host vehicle of the presence of the moving body (for example, refer to Japanese Unexamined Patent Publication No. 2009-086839). It should be noted that the wireless communication information is transmitted from a wireless communication terminal possessed by the moving body. Further, the wireless communication information includes, for example, position information indicating a position of the moving body.

An error in movement information of the moving body recognized based on the wireless communication information decreases as a moving speed of the moving body increases. However, a certain period of time is required from when the wireless communication information is transmitted from the wireless communication terminal until the presence of the moving body is recognized. That is, a certain delay occurs in recognition of the presence of the moving body. Then, as the moving speed of the moving body increases, a distance that the moving body moves during the delay time increases. Accordingly, even if the error in the movement information of the moving body is relatively small, if the moving speed of the moving body is high, the influence of the error on recognition accuracy of the moving body increases. Therefore, even if the moving body has a small error in the movement information, when the moving body is recognized based on the wireless communication information and the moving speed of the moving body is high, there is a possibility that the operator of the host vehicle cannot be appropriately notified of the presence of the moving body.

### SUMMARY

An object of the present invention is to provide a vehicle driving assistance apparatus capable of appropriately notifying the operator of the host vehicle of the presence of the moving body.

A vehicle driving assistance apparatus according to the present invention comprises an electronic control unit that performs a notification for notifying an operator of a host vehicle of a presence of a moving body when the electronic control unit recognizes the presence of the moving body based on wireless communication information. The moving body moves along a road that intersects with a traveling road of the host vehicle at an intersection located ahead in a traveling direction of the host vehicle. Furthermore, the moving body moves toward the intersection. The moving body satisfies a predetermined movement state condition. The predetermined movement state condition includes a first movement state condition that a moving speed of the moving body is equal to or lower than a first speed and an intersection arrival margin time is within a range equal to or shorter than a first time and equal to or longer than a second time which is shorter than the first time. The intersection arrival margin time is the time remaining until the moving body arrives at the intersection. The electronic control unit is configured to perform the notification for notifying the operator of the presence of the moving body when the electronic control unit recognizes the presence of the moving body which satisfies the first movement state condition.

According to the vehicle driving assistance apparatus of the present invention, the moving body of which the operator of the host vehicle is notified based on the wireless communication information has a moving speed equal to or lower than the first speed and an intersection arrival margin time within a range equal to or shorter than the first time and equal to or longer than the second time. In this manner, since the moving body having the intersection arrival margin time equal to or longer than the second time is notified, it is possible to suppress the notification based on the wireless communication information of the moving body that has already passed through the intersection during the delay time at a point in time when the vehicle driving assistance apparatus recognizes the moving body based on the wireless communication information, as compared to a case where there is no intersection arrival margin time. Further, by limiting the moving body to be notified to those whose intersection arrival margin time is equal to or shorter than the first time, it is possible to suppress causing annoyance to the operator due to notifying the operator of the host vehicle too early. Accordingly, it is possible to appropriately notify the operator of the host vehicle of the presence of the moving body.

In the vehicle driving assistance apparatus according to an aspect of the present invention, the electronic control unit may be configured to change a manner of the notification when the electronic control unit directly detects the moving body by a vehicle-mounted device of the host vehicle while the electronic control unit performs the notification.

According to the vehicle driving assistance apparatus of this aspect of the present invention, when the moving body is directly detected by the vehicle-mounted device, the manner of the notification is changed. That is, the notification for notifying the operator of the host vehicle of the presence of the moving body is changed from a notification based on the wireless communication information to a notification based on information detected by the vehicle-mounted device. Accordingly, it is possible to appropriately notify the operator of the host vehicle of the presence of the moving body.

In the vehicle driving assistance apparatus according to another aspect of the present invention, the wireless communication information may be provided to the vehicle driving assistance apparatus via a communication network from a wireless communication terminal possessed by the moving body.

A technology for providing various kinds of information from the wireless communication terminal via the communication network is widely spread. According to the vehicle driving assistance apparatus of this aspect of the present invention, the moving body can be recognized by using such a widely spread technology.

In the vehicle driving assistance apparatus according to further another aspect of the present invention, the second time may be longer than the time required from when the wireless communication information is transmitted from the wireless communication terminal until the wireless communication information is provided to the vehicle driving assistance apparatus.

According to the vehicle driving assistance apparatus of this aspect of the present invention, the time until the wireless communication information related to the moving body is provided to the vehicle driving assistance apparatus is reflected in the notification of the presence of the moving body. Accordingly, it is possible to appropriately notify the operator of the host vehicle of the presence of the moving body.

In the vehicle driving assistance apparatus according to further another aspect of the present invention, the first speed may be a speed near the maximum speed normally attainable by a bicycle.

According to the vehicle driving assistance apparatus of this aspect of the present invention, it is possible to appropriately notify the operator of the host vehicle of the presence of the bicycle.

In the vehicle driving assistance apparatus according to further another aspect of the present invention, the predetermined movement state condition may include a second movement state condition that the moving speed of the moving body is equal to or lower than a second speed lower than the first speed. Furthermore, in this aspect, the electronic control unit may be configured to perform the notification for notifying the operator of the presence of the moving body when the electronic control unit recognizes the presence of the moving body satisfying the first movement state condition or the second movement state condition.

According to the vehicle driving assistance apparatus of this aspect of the present invention, based on the wireless communication information, the operator of the host vehicle is notified of the presence of the moving body having a moving speed equal to or lower than the first speed and an intersection arrival margin time within a range equal to or shorter than the first time and equal to or longer than the second time, and the moving body having a moving speed equal to or lower than the second speed which is lower than the first speed. Accordingly, it is possible to appropriately notify the operator of the host vehicle of the presence of the moving body.

In the vehicle driving assistance apparatus according to further another aspect of the present invention, the first speed may be a speed near the maximum speed normally attainable by a bicycle. Furthermore, in this aspect, the second speed may be a speed near the maximum speed normally attainable by a pedestrian.

According to the vehicle driving assistance apparatus of this aspect of the present invention, it is possible to appropriately notify the operator of the host vehicle of the presence of the pedestrian and bicycle.

In the vehicle driving assistance apparatus according to further another aspect of the present invention, the vehicle-mounted device may include at least one image sensor or at least one electromagnetic wave sensor.

According to the vehicle driving assistance apparatus of this aspect of the present invention, when the moving body is directly detected by the image sensor or the electromagnetic wave sensor, a manner of the notification is changed. Accordingly, it is possible to appropriately notify the operator of the host vehicle of the presence of the moving body.

In the vehicle driving assistance apparatus according to further another aspect of the present invention, the wireless communication information may be position information of the moving body, or movement direction information and moving speed information of the moving body.

According to the vehicle driving assistance apparatus of this aspect of the present invention, the moving body can be recognized based on the position information of the moving body, or the movement direction information and moving speed information of the moving body.

In the vehicle driving assistance apparatus according to further another aspect of the present invention, the electronic control unit may be configured not to perform the notification when the moving body does not satisfy the first movement state condition, even when the electronic control unit recognizes the moving body moving toward the intersection along the road which intersects with the traveling road of the host vehicle at the intersection, based on the wireless communication information.

According to the vehicle driving assistance apparatus of this aspect of the present invention, the operator of the host vehicle is notified of the presence of the moving body only when the moving body recognized based on the wireless communication information has a moving speed equal to or lower than the first speed and an intersection arrival margin time within a range equal to or shorter than the first time and equal to or longer than the second time. Accordingly, it is possible to appropriately notify the operator of the host vehicle of the presence of the moving body.

In the vehicle driving assistance apparatus according to further another aspect of the present invention, the electronic control unit may be configured not to perform the notification when the moving body satisfies neither the first movement state condition nor the second movement state condition, even when the electronic control unit recognizes the moving body moving toward the intersection along the road which intersects with the traveling road of the host vehicle at the intersection, based on the wireless communication information.

According to the vehicle driving assistance apparatus of this aspect of the present invention, the operator of the host vehicle is notified of the presence of the moving body only when the moving body recognized based on the wireless communication information has a moving speed equal to or lower than the first speed and an intersection arrival margin time within a range equal to or shorter than the first time and equal to or longer than the second time, or has a moving speed equal to or lower than the second speed which is lower than the first speed. Accordingly, it is possible to appropriately notify the operator of the host vehicle of the presence of the moving body.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a diagram showing a vehicle driving assistance apparatus according to an embodiment of the present invention.

FIG. 2 is a diagram showing a communication network.

FIG. 3 is a flowchart showing a routine executed by the vehicle driving assistance apparatus according to the embodiment of the present invention.

FIG. 4 is a diagram showing an intersection.

FIG. 5 is a diagram explaining a crossing point and the like.

FIG. 6 is a diagram showing a target moving body image displayed by a displaying device.

FIG. 7 is a flowchart showing a routine executed by the vehicle driving assistance apparatus according to the embodiment of the present invention.

FIG. 8 is a flowchart showing a routine executed by the vehicle driving assistance apparatus according to the embodiment of the present invention.

FIG. 9 is a flowchart showing a routine executed by the vehicle driving assistance apparatus according to the embodiment of the present invention.

### DETAILED DESCRIPTION

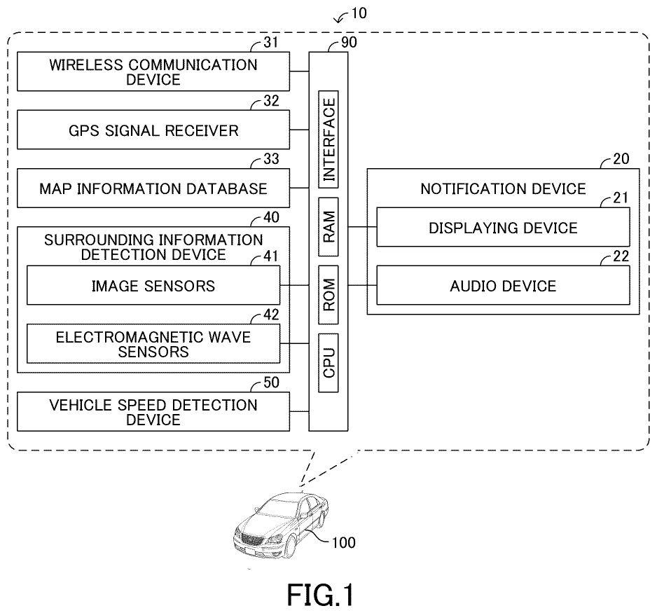

Hereinafter, with reference to the drawings, a vehicle driving assistance apparatus according to an embodiment of the present invention will be described. The vehicle driving assistance apparatus 10 according to the embodiment of the present invention is shown in FIG. 1. The vehicle driving assistance apparatus 10 is mounted on a host vehicle 100. Hereinafter, the vehicle driving assistance apparatus 10 will be explained using an example in which an operator of the host vehicle 100 is a driver of the host vehicle 100 (that is, a person who rides in the host vehicle 100 and drives the host vehicle 100).

However, the operator of the host vehicle 100 may be a remote operator of the host vehicle 100 (that is, a person who remotely drives the host vehicle 100 without riding in the host vehicle 100). When the operator of the host vehicle 100 is the remote operator, the vehicle driving assistance apparatus 10 is mounted on both the host vehicle 100 and a remote operation facility installed outside the host vehicle 100 for remotely driving the host vehicle 100, and the functions of the vehicle driving assistance apparatus 10 described below are performed in a shared manner by the vehicle driving assistance apparatus 10 mounted on the host vehicle 100 and the vehicle driving assistance apparatus 10 mounted on the remote operation facility.

As shown in FIG. 1, the vehicle driving assistance apparatus 10 includes an ECU (i.e., an electronic control unit) 90 as a control device. The ECU 90 includes a microcomputer as a main part. The microcomputer includes a CPU, a computer-readable storage medium, and an interface or the like. The storage medium includes ROM, RAM, and non-volatile memory. The CPU realizes various functions by executing instructions or programs or routines stored in the storage medium. In particular, in this example, the vehicle driving assistance apparatus 10 stores in the storage medium programs that realize various controls executed by the vehicle driving assistance apparatus 10.

It should be noted that in this example, the vehicle driving assistance apparatus 10 includes only one ECU 90, but may include a plurality of ECUs and be configured such that the functions of the vehicle driving assistance apparatus 10 described below are respectively shared and executed by each ECU.

Further, the vehicle driving assistance apparatus 10 may be configured such that the programs stored in the storage medium can be updated by wireless communication (for example, Internet communication) with external devices.

It should be noted that the vehicle driving assistance apparatus 10 is applicable not only to vehicles driven manually by the operator but also to vehicles driven by autonomous driving.

The host vehicle 100 is equipped with a notification device 20. The notification device 20 includes a displaying device 21 and an audio device 22.

The displaying device 21 displays various images. The displaying device 21 includes, for example, a display. The displaying device 21 is electrically connected to the ECU 90. The vehicle driving assistance apparatus 10 displays various images by the displaying device 21.

The audio device 22 outputs various sounds and/or voices. The audio device 22 includes, for example, a speaker. The audio device 22 is electrically connected to the ECU 90. The vehicle driving assistance apparatus 10 outputs various sounds and/or voices by the audio device 22.

Furthermore, the host vehicle 100 is equipped with, as vehicle-mounted devices, a wireless communication device 31, a GPS signal receiver 32, a map information database 33, a surrounding information detection device 40, and a vehicle speed detection device 50.

The wireless communication device 31 receives wireless signals provided from outside the host vehicle 100. The wireless communication device 31 is electrically connected to the ECU 90. The vehicle driving assistance apparatus 10 receives the wireless signals via the wireless communication device 31. The vehicle driving assistance apparatus 10 acquires information related to a moving body 200 as wireless communication information IW based on the wireless signals.

In this example, the moving body 200 possesses a wireless communication terminal 201. The wireless communication terminal 201 has a wireless communication function. The wireless communication terminal 201 is, for example, a so-called mobile phone. The wireless communication terminal 201 transmits wireless signals indicating a position of the moving body 200 (more specifically, a position of the wireless communication terminal 201) to the outside. Alternatively, the wireless communication terminal 201 transmits wireless signals indicating a movement direction and a moving speed of the moving body 200 (more specifically, a movement direction and a moving speed of the wireless communication terminal 201) to the outside.

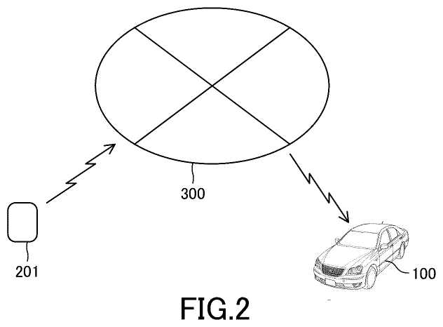

As shown in FIG. 2, the wireless signals transmitted from the wireless communication terminal 201 are provided to the vehicle driving assistance apparatus 10 via a communication network 300. The vehicle driving assistance apparatus 10 acquires position information of the moving body 200, or movement direction information and moving speed information of the moving body 200 as wireless communication information IW based on the provided wireless signals.

Thus, in this example, the wireless communication information IW is provided to the vehicle driving assistance apparatus 10 via the communication network 300 from the wireless communication terminal 201 possessed by the moving body 200. Also, the wireless communication information IW is position information of the moving body 200, or movement direction information and moving speed information of the moving body 200.

It should be noted that the position information of the moving body 200 indicates the position of the moving body 200. The movement direction information of the moving body 200 indicates the direction in which the moving body 200 moves. The moving speed information of the moving body 200 indicates the moving speed of the moving body 200.

Further, in this example, the exchange of wireless communication information between the moving body 200 (more specifically, the wireless communication terminal 201 possessed by the moving body 200) and the vehicle driving assistance apparatus 10 uses so-called V2N technology. Therefore, in this example, the communication network 300 is an Internet communication network that is a part of communication network infrastructure used by V2N technology. However, the present invention is also applicable to cases where infrastructure (or equipment) including communication networks used by so-called V2X technologies including V2N technology is utilized.

The GPS signal receiver 32 receives so-called GPS signals. The GPS signal receiver 32 is electrically connected to the ECU 90. The vehicle driving assistance apparatus 10 receives GPS signals via the GPS signal receiver 32. The vehicle driving assistance apparatus 10 acquires a current position of the host vehicle 100 as a current position Pnow based on the GPS signals.

The map information database 33 stores map information. The map information database 33 is electrically connected to the ECU 90. The vehicle driving assistance apparatus 10 acquires map information around the host vehicle 100 as map information IM from the map information database 33 based on the current position Pnow of the host vehicle 100.

The surrounding information detection device 40 detects information related to the surroundings of the host vehicle 100. The surrounding information detection device 40 includes a plurality of image sensors 41 and a plurality of electromagnetic wave sensors 42.

The image sensors 41 capture images around the host vehicle 100. The image sensors 41 are, for example, camera sensors. The image sensors 41 are electrically connected to the ECU 90. The vehicle driving assistance apparatus 10 acquires image data or image information around the host vehicle 100 as surrounding information IS by the image sensors 41.

The electromagnetic wave sensors 42 acquire information related to objects around the host vehicle 100. The electromagnetic wave sensors 42 are, for example, millimeter wave radars. The electromagnetic wave sensors 42 are electrically connected to the ECU 90. The vehicle driving assistance apparatus 10 acquires object data or object information related to objects around the host vehicle 100 as surrounding information IS by the electromagnetic wave sensors 42.

The vehicle speed detection device 50 detects a traveling speed of the host vehicle 100. The vehicle speed detection device 50 includes, for example, wheel rotation speed sensors provided on each wheel of the host vehicle 100. The vehicle speed detection device 50 is electrically connected to the ECU 90. The vehicle driving assistance apparatus 10 acquires the traveling speed of the host vehicle 100 as a host vehicle speed Ve by the vehicle speed detection device 50.

### Operation of Vehicle Driving Assistance Apparatus

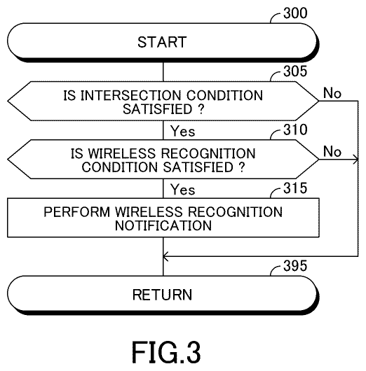

Next, operation of the vehicle driving assistance apparatus 10 will be described. The vehicle driving assistance apparatus 10 is configured to execute a routine shown in FIG. 3 at predetermined time intervals to perform a wireless recognition notification described later when a predetermined condition is satisfied.

At a predetermined timing, the vehicle driving assistance apparatus 10 starts processing from a step S300 of the routine shown in FIG. 3 and proceeds with the process to a step S305 to determine whether or not an intersection condition CI is satisfied.

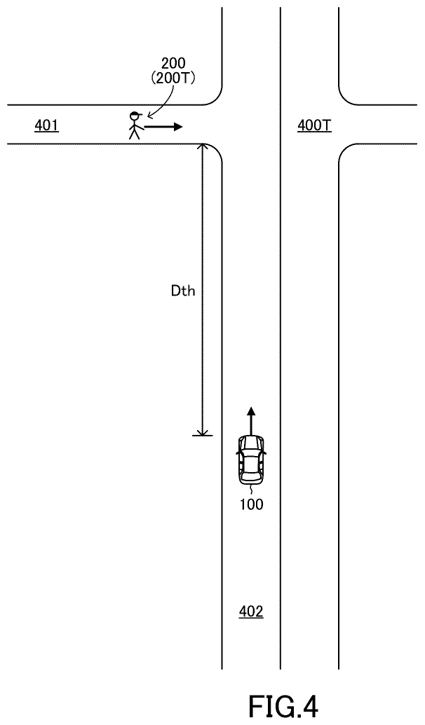

The intersection condition CI is a condition that a target intersection 400T exists. As shown in FIG. 4, the target intersection 400T is ahead of the host vehicle 100 in the traveling direction of the host vehicle 100. In particular, the target intersection 400T is ahead of the host vehicle 100 in the traveling direction of the host vehicle 100 and exists within a predetermined distance (or an intersection determination distance Dth) from the host vehicle 100.

The vehicle driving assistance apparatus 10 determines whether or not the intersection condition CI is satisfied based on the map information IM. Alternatively, the vehicle driving assistance apparatus 10 determines whether or not the intersection condition CI is satisfied based on the wireless communication information IW. Alternatively, the vehicle driving assistance apparatus 10 determines whether or not the intersection condition CI is satisfied based on the surrounding information IS.

When the vehicle driving assistance apparatus 10 determines “Yes” at the step S305, the vehicle driving assistance apparatus 10 proceeds with the process to a step S310 to determine whether or not a wireless recognition condition CW is satisfied.

The wireless recognition condition CW is a condition that a target moving body 200T exists.

The target moving body 200T is a moving body 200 which moves toward the target intersection 400T along an intersecting road 401 and satisfies a predetermined movement state condition CM.

As shown in FIG. 4, the intersecting road 401 intersects with a traveling road 402 of the host vehicle 100 at the target intersection 400T.

The predetermined movement state condition CM is a condition (or a first movement state condition) that a moving speed Vm of the moving body 200 is equal to or lower than a first speed V1 and an intersection arrival margin time TTC is within a range equal to or shorter than a first time TTC1 and equal to or longer than a second time TTC2 which is shorter than the first time TTC1.

The intersection arrival margin time TTC is a margin time remaining until the moving body 200 arrives at the target intersection 400T. More specifically, the intersection arrival margin time TTC is the time required for the moving body 200 to arrive at a crossing point PC. Therefore, the intersection arrival margin time TTC is the time obtained by dividing a distance Dm from the moving body 200 to the target intersection 400T (i.e., the crossing point PC) by the moving speed Vm of the moving body 200.

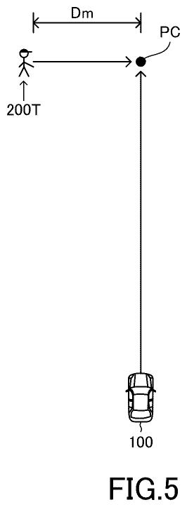

As shown in FIG. 5, the distance Dm from the moving body 200 to the target intersection 400T is from the moving body 200 to the crossing point PC. The crossing point PC is a point where an intended traveling route of the host vehicle 100 and an intended movement path of the moving body 200 intersect.

The first speed V1 is a speed near the maximum moving speed normally attainable by a bicycle. In other words, the first speed V1 is a speed by which it is possible to distinguish whether the moving body 200 is a bicycle or a pedestrian who moves at a speed lower than that of a bicycle, or whether the moving body 200 is a bicycle or a moving body 200 which moves at a speed higher than that of a bicycle. The moving bodies 200 moving at a speed higher than that of bicycles here are motorcycles and automobiles.

The first time TTC1 is set to a time by which a notification of the presence of the moving body 200 can be performed at an appropriate timing. In particular, in this example, the first time TTC1 is the minimum time required for the driver to avoid a collision between the target moving body 200T and the host vehicle 100 after the driver is notified of the presence of the target moving body 200T which moves at a moving speed Vm that is equal to or lower than the first speed V1 and equal to or higher than the second speed V2. Further, in this example, the second time TTC2 is the time (delay time) required from when the wireless signal (that is, the wireless communication information IW) is transmitted from the wireless communication terminal 201 possessed by the moving body 200 until the wireless signal (that is, the wireless communication information IW) is provided to the wireless communication device 31 of the host vehicle 100.

When the vehicle driving assistance apparatus 10 determines “Yes” at the step S310, the vehicle driving assistance apparatus 10 proceeds with the process to a step S315 to perform a wireless recognition notification. Then, the vehicle driving assistance apparatus 10 proceeds with the process to a step S395 to terminate the process of this routine once.

The wireless recognition notification is for notifying the driver of the host vehicle 100 of the presence of the target moving body 200T. In this example, the wireless recognition notification is performed by the notification device 20 in a predetermined manner.

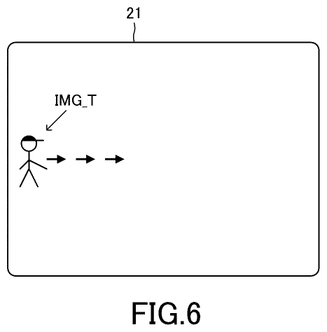

For example, as shown in FIG. 6, the wireless recognition notification is performed by displaying a target moving body image IMG_T by the displaying device 21 in a predetermined manner.

Alternatively, in addition to or instead of this, the wireless recognition notification is performed by outputting a sound from the audio device 22 in a predetermined pattern.

Alternatively, in addition to or instead of this, the wireless recognition notification is performed by outputting a voice with predetermined content from the audio device 22.

It should be noted that the target moving body image IMG_T represents the target moving body 200T. In particular, when the vehicle driving assistance apparatus 10 recognizes that the target moving body 200T is a pedestrian, the target moving body image IMG_T can represent a pedestrian. Also, when the vehicle driving assistance apparatus 10 recognizes that the target moving body 200T is a bicycle, the target moving body image IMG_T can represent a bicycle. In this example, the type of the target moving body 200T is determined by a known method available.

Further, in this example, the wireless recognition notification continues until the target moving body 200T enters the target intersection 400T. Alternatively, the wireless recognition notification continues for a predetermined time Tth.

Further, when the vehicle driving assistance apparatus 10 determines “No” at the step S305 or step S310, the vehicle driving assistance apparatus 10 proceeds with the process directly to the step S395 to terminate the process of this routine once.

Thus, the vehicle driving assistance apparatus 10 is configured not to perform the wireless recognition notification when the moving body 200 does not satisfy the predetermined movement state condition CM (i.e., the first movement state condition), even when the vehicle driving assistance apparatus 10 recognizes a moving body 200 moving toward the target intersection 400T along a road (i.e., the intersecting road 401) intersecting with the traveling road 402 of the host vehicle 100 at the target intersection 400T based on the wireless communication information IW.

The above is the operation of the vehicle driving assistance apparatus 10.

The error in the movement information of the moving body 200 recognized based on the wireless communication information IW decreases as the moving speed Vm of the moving body 200 increases. However, it takes a certain time from when the wireless communication information IW is transmitted from the wireless communication terminal 201 until the presence of the moving body 200 is recognized. That is, a certain delay time occurs in recognizing the presence of the moving body 200. Moreover, the higher the moving speed Vm of the moving body 200, the longer the distance the moving body 200 moves during the delay time. Therefore, even when the error in the movement information of the moving body 200 is relatively small, if the moving speed Vm of the moving body 200 is high, the influence of the error on the recognition accuracy of the moving body 200 is large. For this reason, if the moving body 200 has small movement information error when the moving body 200 is recognized based on the wireless communication information IW and the moving speed Vm of the moving body 200 is high, the driver of the host vehicle 100 may not be appropriately notified of the presence of the moving body 200.

According to the vehicle driving assistance apparatus 10, the moving body 200 of which the driver of the host vehicle 100 is notified based on the wireless communication information IW has a moving speed Vm equal to or lower than the first speed V1 and an intersection arrival margin time TTC to the intersection (i.e., the target intersection 400T) within a range equal to or shorter than the first time TTC1 and equal to or longer than the second time TTC2 which is shorter than the first time TTC1. Since the moving body 200 having the intersection arrival margin time TTC equal to or longer than the second time TTC2 is notified, it is possible to suppress the notification based on the wireless communication information IW of the moving body 200 that has already passed through the intersection (i.e., the target intersection 400T) during the delay time at a point in time when the vehicle driving assistance apparatus 10 recognizes the moving body 200 based on the wireless communication information IW, as compared to a case where there is no intersection arrival margin time TTC. Further, by limiting the moving body 200 to be notified to those whose intersection arrival margin time TTC is equal to or shorter than the first time TTC1, it is possible to suppress causing annoyance to the driver due to notifying the driver too early.

It should be noted that the present invention is not limited to the aforementioned embodiments, and various modifications can be employed within the scope of the invention.

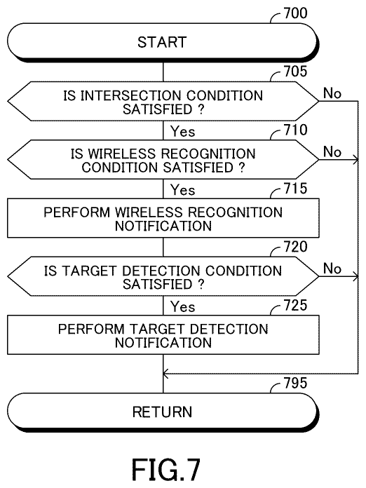

For example, the vehicle driving assistance apparatus 10 may be configured to execute a routine shown in FIG. 7 at predetermined time intervals. In this case, at a predetermined timing, the vehicle driving assistance apparatus 10 starts processing from a step S700 of the routine shown in FIG. 7 and proceeds with the process to a step S705 to determine whether or not the intersection condition CI is satisfied.

When the vehicle driving assistance apparatus 10 determines “Yes” at the step S705, the vehicle driving assistance apparatus 10 proceeds with the process to a step S710 to determine whether or not the wireless recognition condition CW is satisfied.

When the vehicle driving assistance apparatus 10 determines “Yes” at the step S710, the vehicle driving assistance apparatus 10 proceeds with the process to a step S715 to perform the wireless recognition notification. The wireless recognition notification performed at the step S715 is the same as the wireless recognition notification performed at the step S315.

Next, the vehicle driving assistance apparatus 10 proceeds with the process to a step S720 to determine whether or not a target detection condition CT is satisfied.

The target detection condition CT is a condition that the target moving body 200T is detected based on the surrounding information IS.

When the vehicle driving assistance apparatus 10 determines “Yes” at the step S720, the vehicle driving assistance apparatus 10 proceeds with the process to a step S725 to terminate the wireless recognition notification and perform a target detection notification. Then, the vehicle driving assistance apparatus 10 proceeds with the process to a step S795 to terminate the process of this routine once.

The target detection notification is for notifying the driver of the host vehicle 100 of the presence of the target moving body 200T. In this example, the target detection notification is performed by the notification device 20. However, the target detection notification is performed in a manner different from the manner used in the wireless recognition notification.

For example, the target detection notification is performed by displaying the target moving body image IMG_T by the displaying device 21 in a manner different from the predetermined manner used in the wireless recognition notification. In this case, for example, in the target detection notification, the vehicle driving assistance apparatus 10 displays the target moving body image IMG_T in a size or color different from that used in the wireless recognition notification.

Alternatively, in addition to or instead of this, the target detection notification is performed by outputting a sound from the audio device 22 in a pattern different from the predetermined pattern used in the wireless recognition notification. In this case, for example, when the vehicle driving assistance apparatus 10 outputs a short sound once from the audio device 22 in the wireless recognition notification, the vehicle driving assistance apparatus 10 outputs two short sounds consecutively from the audio device 22 in the target detection notification.

Alternatively, in addition to or instead of this, the target detection notification is performed by outputting a voice with content different from the predetermined content used in the wireless recognition notification from the audio device 22.

Thus, the vehicle driving assistance apparatus 10 is configured to change the manner of notification when the vehicle driving assistance apparatus 10 directly detects the target moving body 200T by the vehicle-mounted device (in this example, the surrounding information detection device 40) of the host vehicle 100 while the vehicle driving assistance apparatus 10 performs the wireless recognition notification.

Further, when the vehicle driving assistance apparatus 10 determines “No” at the step S705, step S710, or step S720, the vehicle driving assistance apparatus 10 proceeds with the process directly to the step S795 to terminate the process of this routine once.

When the target moving body 200T recognized based on the wireless communication information IW is detected by the vehicle-mounted device such as the surrounding information detection device 40, it is preferable that the notification of the target moving body 200T is performed based on the information detected by such a vehicle-mounted device.

According to the vehicle driving assistance apparatus 10 of this example, when the target moving body 200T is detected based on the surrounding information IS while the wireless recognition notification is performed, the driver of the host vehicle 100 is notified of the presence of the target moving body 200T in a manner different from the manner used in the wireless recognition notification. Therefore, it is possible to appropriately notify the driver of the host vehicle 100 of the presence of the moving body 200.

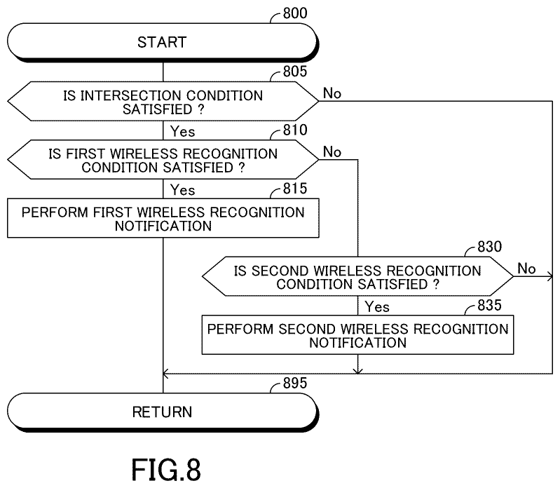

Alternatively, the vehicle driving assistance apparatus 10 may be configured to execute a routine shown in FIG. 8 at predetermined time intervals. In this case, at a predetermined timing, the vehicle driving assistance apparatus 10 starts processing from a step S800 of the routine shown in FIG. 8 and proceeds with the process to a step S805 to determine whether or not the intersection condition CI is satisfied.

When the vehicle driving assistance apparatus 10 determines “Yes” at the step S805, the vehicle driving assistance apparatus 10 proceeds with the process to a step S810 to determine whether or not a first wireless recognition condition CW1 is satisfied.

The first wireless recognition condition CW1 is a condition that a first target moving body 200T1 exists. The first target moving body 200T1 is the moving body 200 moving toward the target intersection 400T along the intersecting road 401 and satisfying a predetermined first movement state condition CM1. The predetermined first movement state condition CM1 is a condition that the moving speed Vm of the moving body 200 is equal to or lower than the first speed V1 and the intersection arrival margin time TTC is within a range equal to or shorter than the first time TTC1 and equal to or longer than the second time TTC2 which is shorter than the first time TTC1.

As described above, the first speed V1 is a speed near the maximum speed normally attainable by a bicycle. In other words, the first speed V1 can distinguish whether the moving body 200 is a bicycle or a pedestrian who moves at a moving speed Vm lower than that of a bicycle, or whether or not the moving body 200 is a moving body 200 which moves at a moving speed Vm higher than that of a bicycle. The moving bodies 200 other than bicycles here are motorcycles and automobiles.

When the vehicle driving assistance apparatus 10 determines “Yes” at the step S810, the vehicle driving assistance apparatus 10 proceeds with the process to a step S815 to perform a first wireless recognition notification. Then, the vehicle driving assistance apparatus 10 proceeds with the process to a step S895 to terminate the process of this routine once.

The first wireless recognition notification is for notifying the driver of the host vehicle 100 of the presence of the first target moving body 200T1. In this example, the first wireless recognition notification is performed by the notification device 20 in a predetermined manner.

For example, the first wireless recognition notification is performed by displaying a first target moving body image IMG_T1 by the displaying device 21 in a predetermined manner.

Alternatively, in addition to or instead of this, the first wireless recognition notification is performed by outputting a sound from the audio device 22 in a predetermined pattern.

Alternatively, in addition to or instead of this, the first wireless recognition notification is performed by outputting a voice with predetermined content from the audio device 22.

It should be noted that the first target moving body image IMG_T1 represents the first target moving body 200T1. In particular, the first target moving body image IMG_T1 represents a bicycle.

Further, in this example, the first wireless recognition notification continues until the first target moving body 200T1 enters the target intersection 400T. Alternatively, the first wireless recognition notification continues for a predetermined time Tth.

On the other hand, when the vehicle driving assistance apparatus 10 determines “No” at the step S810, the vehicle driving assistance apparatus 10 proceeds with the process to a step S830 to determine whether or not a second wireless recognition condition CW2 is satisfied.

The second wireless recognition condition CW2 is a condition that a second target moving body 200T2 exists. The second target moving body 200T2 is the moving body 200 moving toward the target intersection 400T along the intersecting road 401 and satisfying a predetermined second movement state condition CM2. The predetermined second movement state condition CM2 is a condition that the moving speed Vm of the moving body 200 is equal to or lower than the second speed V2 which is lower than the first speed V1.

The second speed V2 is a speed near the maximum speed normally attainable by a pedestrian. In other words, the second speed V2 can distinguish whether or not the moving body 200 is a pedestrian or whether or not the moving body 200 is a moving body other than a pedestrian. The moving bodies 200 other than pedestrians here are bicycles, motorcycles, and automobiles.

When the vehicle driving assistance apparatus 10 determines “Yes” at the step S830, the vehicle driving assistance apparatus 10 proceeds with the process to a step S835 to perform a second wireless recognition notification. Then, the vehicle driving assistance apparatus 10 proceeds with the process to the step S895 to terminate the process of this routine once.

The second wireless recognition notification is for notifying the driver of the host vehicle 100 of the presence of the second target moving body 200T2. In this example, the second wireless recognition notification is performed by the notification device 20 in a predetermined manner.

For example, the second wireless recognition notification is performed by displaying a second target moving body image IMG_T2 by the displaying device 21 in a predetermined manner.

Alternatively, in addition to or instead of this, the second wireless recognition notification is performed by outputting a sound from the audio device 22 in a predetermined pattern.

Alternatively, in addition to or instead of this, the second wireless recognition notification is performed by outputting a voice with predetermined content from the audio device 22.

It should be noted that the second target moving body image IMG_T2 represents the second target moving body 200T2. In particular, the second target moving body image IMG_T2 represents a pedestrian.

Further, in this example, the second wireless recognition notification continues until the second target moving body 200T2 enters the target intersection 400T. Alternatively, the second wireless recognition notification continues for a predetermined time Tth.

Further, when the vehicle driving assistance apparatus 10 determines “No” at the step S805 or step S830, the vehicle driving assistance apparatus 10 proceeds with the process directly to the step S895 to terminate the process of this routine once.

The error in the movement information of the moving body 200 recognized based on the wireless communication information IW increases as the moving speed Vm of the moving body 200 decreases. Therefore, the error of the intersection arrival margin time TTC calculated based on the movement information also increases and thus, even if the notification timing for the moving bodies 200 at the low moving speed Vm is defined by the intersection arrival margin time TTC, the accuracy is low.

On the other hand, as the moving speed Vm of the moving body 200 decreases, the distance the moving body 200 moves during the delay time from when the wireless communication terminal 201 transmits the wireless communication information IW to when the presence of the moving body 200 is recognized decreases. Therefore, even if the error in the movement information of the moving body 200 is relatively large, if the moving speed Vm of the moving body 200 is low, the influence of the delay time on recognition accuracy is small.

Therefore, when the moving body 200 such as a pedestrian having the low moving speed Vm moves toward the intersection (i.e., the target intersection 400T), the possibility that the moving body 200 has already passed through the intersection (i.e., the target intersection 400T) during the delay time when the vehicle driving assistance apparatus 10 recognizes the moving body 200 based on the wireless communication information IW is low, and the driver is unlikely to feel discomfort even if the vehicle driving assistance apparatus 10 performs the notice to the driver when the vehicle driving assistance apparatus 10 recognizes the moving body 200.

According to the vehicle driving assistance apparatus 10 of this example, it is possible to appropriately notify the driver of the host vehicle 100 of the presence of the moving body 200 (e.g., a bicycle) having the moving speed Vm equal to or lower than the first speed V1 and the margin time (i.e., the intersection arrival margin time TTC) remaining until the moving body 200 arrives at the intersection (i.e., the target intersection 400T) within a range equal to or shorter than the first time TTC1 and equal to or longer than the second time TTC2 which is shorter than the first time TTC1, and the presence of the moving body 200 (e.g., a pedestrian) having the moving speed Vm equal to or lower than the second speed V2 which is lower than the first speed V1, based on the wireless communication information IW.

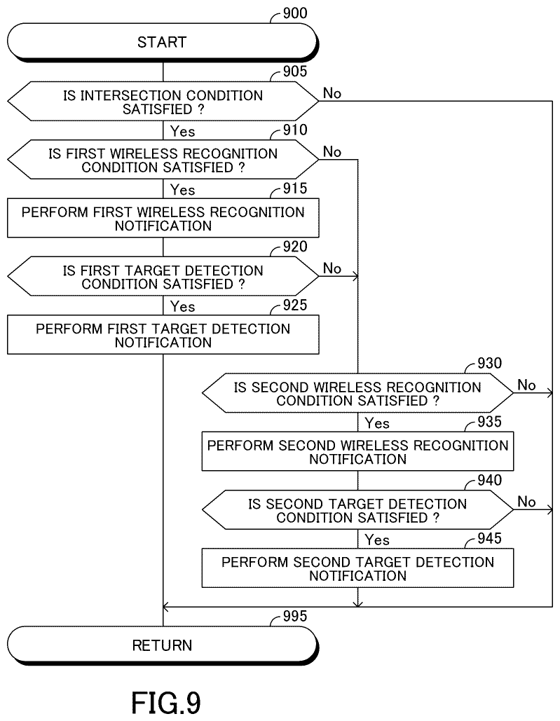

Alternatively, the vehicle driving assistance apparatus 10 may be configured to execute a routine shown in FIG. 9 at predetermined time intervals. In this case, at a predetermined timing, the vehicle driving assistance apparatus 10 starts processing from a step S900 of the routine shown in FIG. 9 and proceeds with the process to a step S905 to determine whether or not the intersection condition CI is satisfied.

When the vehicle driving assistance apparatus 10 determines “Yes” at the step S905, the vehicle driving assistance apparatus 10 proceeds with the process to a step S910 to determine whether or not the first wireless recognition condition CW1 is satisfied.

When the vehicle driving assistance apparatus 10 determines “Yes” at the step S910, the vehicle driving assistance apparatus 10 proceeds with the process to a step S915 to perform the first wireless recognition notification. The first wireless recognition notification performed at the step S915 is the same as the first wireless recognition notification performed at the step S815.

Next, the vehicle driving assistance apparatus 10 proceeds with the process to a step S920 to determine whether or not a first target detection condition CT1 is satisfied.

The first target detection condition CT1 is a condition that the first target moving body 200T1 is detected based on the surrounding information IS.

When the vehicle driving assistance apparatus 10 determines “Yes” at the step S920, the vehicle driving assistance apparatus 10 proceeds with the process to a step S925 to perform a first target detection notification. Then, the vehicle driving assistance apparatus 10 proceeds with the process to a step S995 to terminate the process of this routine once.

The first target detection notification is for notifying the driver of the host vehicle 100 of the presence of the first target moving body 200T1. In this example, the first target detection notification is performed by the notification device 20. However, the first target detection notification is performed in a manner different from the manner used in the first wireless recognition notification.

For example, the first target detection notification is performed by displaying the first target moving body image IMG_T1 by the displaying device 21 in a manner different from the predetermined manner used in the first wireless recognition notification.

Alternatively, in addition to or instead of this, the first target detection notification is performed by outputting a sound from the audio device 22 in a pattern different from the predetermined pattern used in the first wireless recognition notification.

Alternatively, in addition to or instead of this, the first target detection notification is performed by outputting a voice with content different from the predetermined content used in the first wireless recognition notification from the audio device 22.

Accordingly, the vehicle driving assistance apparatus 10 is configured to change the manner of notification when the vehicle driving assistance apparatus 10 directly detects the first target moving body 200T1 by the vehicle-mounted device (i.e., the surrounding information detection device 40) of the host vehicle 100 while the vehicle driving assistance apparatus 10 performs the first wireless recognition notification.

On the other hand, when the vehicle driving assistance apparatus 10 determines “No” at the step S910 or step S920, the vehicle driving assistance apparatus 10 proceeds with the process to a step S930 to determine whether or not a second wireless recognition condition CW2 is satisfied.

When the vehicle driving assistance apparatus 10 determines “Yes” at the step S930, the vehicle driving assistance apparatus 10 proceeds with the process to a step S935 to perform the second wireless recognition notification. The second wireless recognition notification performed at the step S935 is the same as the second wireless recognition notification performed at the step S835.

Next, the vehicle driving assistance apparatus 10 proceeds with the process to a step S940 to determine whether or not a second target detection condition CT2 is satisfied.

The second target detection condition CT2 is a condition that the second target moving body 200T2 is detected based on the surrounding information IS.

When the vehicle driving assistance apparatus 10 determines “Yes” at the step S940, the vehicle driving assistance apparatus 10 proceeds with the process to a step S945 to perform a second target detection notification. Then, the vehicle driving assistance apparatus 10 proceeds with the process to the step S995 to terminate the process of this routine once.

The second target detection notification is for notifying the driver of the host vehicle 100 of the presence of the second target moving body 200T2. In this example, the second target detection notification is performed by the notification device 20. However, the second target detection notification is performed in a manner different from the manner used in the second wireless recognition notification.

For example, the second target detection notification is performed by displaying the second target moving body image IMG_T2 by the displaying device 21 in a manner different from the predetermined manner used in the second wireless recognition notification.

Alternatively, in addition to or instead of this, the second target detection notification is performed by outputting a sound from the audio device 22 in a pattern different from the predetermined pattern used in the second wireless recognition notification.

Alternatively, in addition to or instead of this, the second target detection notification is performed by outputting a voice with content different from the predetermined content used in the second wireless recognition notification from the audio device 22.

Accordingly, the vehicle driving assistance apparatus 10 is configured to change the manner of notification when the vehicle driving assistance apparatus 10 directly detects the second target moving body 200T2 by the vehicle-mounted device (i.e., the surrounding information detection device 40) of the host vehicle 100 while the vehicle driving assistance apparatus 10 performs the second wireless recognition notification.

Further, when the vehicle driving assistance apparatus 10 determines “No” at the step S905, step S930, or step S940, the vehicle driving assistance apparatus 10 proceeds with the process directly to the step S995 to terminate the process of this routine once.

According to the vehicle driving assistance apparatus 10 of this example, it is possible to appropriately notify the driver of the host vehicle 100 of the presence of the moving body 200 (e.g., a bicycle) having the moving speed Vm equal to or lower than the first speed V1 and the margin time (i.e., the intersection arrival margin time TTC) remaining until the moving body 200 arrives at the intersection (i.e., the target intersection 400T) within a range equal to or shorter than the first time TTC1 and equal to or longer than the second time TTC2 which is shorter than the first time TTC1, and the presence of a moving body 200 (e.g., a pedestrian) having the moving speed Vm equal to or lower than the second speed V2 which is lower than the first speed V1, based on the wireless communication information IW.

Furthermore, according to the vehicle driving assistance apparatus 10 of this example, when the target moving body 200T is detected based on the surrounding information IS while the wireless recognition notification is performed, the driver of the host vehicle 100 is notified of the presence of the target moving body 200T in a manner different from the manner used in the wireless recognition notification. Therefore, it is possible to appropriately notify the driver of the host vehicle 100 of the presence of the moving body 200.

What is claimed is:

1. A vehicle driving assistance apparatus comprising an electronic control unit that performs a notification for notifying an operator of a host vehicle of a presence of a moving body when the electronic control unit recognizes the presence of the moving body based on wireless communication information,
the moving body moving along a road that intersects with a traveling road of the host vehicle at an intersection located ahead in a traveling direction of the host vehicle,
the moving body moving toward the intersection, and
the moving body satisfying a predetermined movement state condition,
wherein the predetermined movement state condition includes a first movement state condition that a moving speed of the moving body is equal to or lower than a first speed and an intersection arrival margin time is within a range equal to or shorter than a first time and equal to or longer than a second time which is shorter than the first time,
the intersection arrival margin time being the time remaining until the moving body arrives at the intersection, and
wherein the electronic control unit is configured to perform the notification for notifying the operator of the presence of the moving body when the electronic control unit recognizes the presence of the moving body which satisfies the first movement state condition.

2. The vehicle driving assistance apparatus according to claim 1, wherein the electronic control unit is configured to change a manner of the notification when the electronic control unit directly detects the moving body by a vehicle-mounted device of the host vehicle while the electronic control unit performs the notification.

3. The vehicle driving assistance apparatus according to claim 1, wherein the wireless communication information is provided to the vehicle driving assistance apparatus via a communication network from a wireless communication terminal possessed by the moving body.

4. The vehicle driving assistance apparatus according to claim 3, wherein the second time is longer than the time required from when the wireless communication information is transmitted from the wireless communication terminal until the wireless communication information is provided to the vehicle driving assistance apparatus.

5. The vehicle driving assistance apparatus according to claim 1, wherein the first speed is a speed near the maximum speed normally attainable by a bicycle.

6. The vehicle driving assistance apparatus according to claim 1,
wherein the predetermined movement state condition includes a second movement state condition that the moving speed of the moving body is equal to or lower than a second speed lower than the first speed, and
wherein the electronic control unit is configured to perform the notification for notifying the operator of the presence of the moving body when the electronic control unit recognizes the presence of the moving body satisfying the first movement state condition or the second movement state condition.

7. The vehicle driving assistance apparatus according to claim 6,
wherein the first speed is a speed near the maximum speed normally attainable by a bicycle, and
wherein the second speed is a speed near the maximum speed normally attainable by a pedestrian.

8. The vehicle driving assistance apparatus according to claim 2, wherein the vehicle-mounted device includes at least one image sensor or at least one electromagnetic wave sensor.

9. The vehicle driving assistance apparatus according to claim 1, wherein the wireless communication information is position information of the moving body, or movement direction information and moving speed information of the moving body.

10. The vehicle driving assistance apparatus according to claim 1, wherein the electronic control unit is configured not to perform the notification when the moving body does not satisfy the first movement state condition, even when the electronic control unit recognizes the moving body moving toward the intersection along the road which intersects with the traveling road of the host vehicle at the intersection, based on the wireless communication information.

11. The vehicle driving assistance apparatus according to claim 6, wherein the electronic control unit is configured not to perform the notification when the moving body satisfies neither the first movement state condition nor the second movement state condition, even when the electronic control unit recognizes the moving body moving toward the intersection along the road which intersects with the traveling road of the host vehicle at the intersection, based on the wireless communication information.
